(19) United States
(12) Patent Application Publication
(10) Pub. No.: US 2021/0166082 A1
(43) Pub. Date: Jun. 3, 2021

(54) DATA ANALYSIS SYSTEM AND DATA ANALYSIS METHOD

(71) Applicant: Nippon Telegraph and Telephone Corporation, Tokyo (JP)

(72) Inventors: Takayuki Ogasawara, Tokyo (JP); Osamu Saisho, Tokyo (JP); Rieko Sato, Tokyo (JP); Shingo Tsukada, Tokyo (JP)

(21) Appl. No.: 15/734,365

(22) PCT Filed: May 16, 2019
(86) PCT No.: PCT/JP2019/019491

§ 371 Date: Dec. 2, 2020

(30) Foreign Application Priority Data
Jun. 4, 2018 (JP) 2018-106704

(51) Int. Cl. G06K 9/62; G06N 20/10

(52) U.S. Cl. CPC G06K 9/6264; G06K 9/6265; G06K 2009/6864; G06K 9/6227; G06N 20/10

(57) ABSTRACT

A method for a data analysis system includes measuring, by a sensor terminal of the data analysis system, sensor data; receiving, by a teacher data input terminal of the data analysis system, teacher data input into the teacher data input terminal; and generating, a server by the data analysis system, a classifier according to learning through the sensor data and the teacher data. The sensor terminal transmits the sensor data to the server, receives the classifier generated by the server, analyzes the sensor data according to the classifier, and transmits an analysis result of the analyzing the sensor data to the server. The teacher data input terminal transmits the teacher data to the server. The server generates the classifier, analyzes the sensor data according to the classifier, transmits the classifier to the sensor terminal, and receives the analysis result from the sensor terminal.

### CROSS-REFERENCE TO RELATED APPLICATIONS

This application is a national phase entry of PCT Application No. PCT/JP2019/019491, filed on May 16, 2019, which claims priority to Japanese Application No. 2018-106704, filed on Jun. 4, 2018, which applications are hereby incorporated herein by reference.

### TECHNICAL FIELD

The present invention relates to a data analysis system and a data analysis method that analyze acquired sensor data and present analysis results.

### BACKGROUND

In recent years, data analysis systems have been proposed, which collect vital information, vehicle information, environment information or the like in a cloud to integrally visualize, analyze, and handle information (e.g., see Non-Patent Literature 1).

FIG. 12 is a diagram illustrating an overview of a conventional data analysis system. The data analysis system is constructed of a sensor terminal that measures sensor data such as vital information, vehicle information, and environment information, a server that accumulates sensor data transmitted from the sensor terminal and analyzes the accumulated data using an analysis algorithm and a viewer that displays an analysis result obtained by analyzing the data.

### CITATION LIST

### Non-Patent Literature

Non-Patent Literature 1: “Natural Sensing using hitoe and Initiatives for Utilization thereof”, NTT Technical Journal 29(7), 13-18, 2017-07, The Telecommunications Association.

### SUMMARY

### Technical Problem

Here, when sensor data measured by the sensor terminal is accumulated on a server such as in a cloud through a wireless network of LTE or the like, the sensor data is continuously coming and going over the network for a long time with a certain amount of packets always flowing, and this results in a problem of causing a pressure on a network band. The sensor data is analyzed on the cloud, and the analysis result needs to be acquired through the network, and this also results in a problem of causing delay before the latest analysis result is reflected.

An object of embodiments of the present invention, which has been made in view of the above-described problems, is to provide a data analysis system capable of reducing both pressure on a network band through transmission/reception of sensor data when making a data analysis and delay when the data analysis result is reflected.

### Means for Solving the Problem

In order to solve the above-described problems, a data analysis system of embodiments of the present invention is a data analysis system provided with a sensor terminal that measures sensor data, a teacher data input terminal for inputting teacher data and a server that generates a classifier through learning using the sensor data and the teacher data, in which the sensor terminal includes a sensor data transmission unit that transmits the measured sensor data to the server, a classifier reception unit that receives the classifier generated by the server, an analysis execution unit that analyzes the sensor data using the classifier and an analysis result transmission unit that transmits the analysis result of the analysis execution unit to the server, wherein the teacher data input terminal includes a teacher data transmission unit that transmits the inputted teacher data to the server, the server includes a classifier generation unit that generates a classifier through learning using the sensor data received from the sensor terminal and the teacher data received from the teacher data input terminal, an analysis execution unit that analyzes the sensor data using the classifier, a classifier transmission unit that transmits the classifier to the sensor terminal and an analysis result reception unit that receives the analysis result from the sensor terminal.

The data analysis system of embodiments of the present invention may include a plurality of the sensor terminals and a plurality of the teacher data input terminals, some of the sensor terminals may continue to transmit the sensor data after generating the classifier, some of the teacher data input terminals may continue to transmit the teacher data, the classifier generation unit may update the classifier through relearning using the sensor data received from the some of the sensor terminals and the teacher data received from the some of the teacher data input terminals and the classifier transmission unit may transmit the updated classifier to the some of the sensor terminals.

The classifier generation unit may include a plurality of analysis algorithms and select an analysis algorithm to learn in accordance with at least one of a scale and a type of the sensor data and the teacher data and analysis performance of the classifier.

The classifier generation unit may classify the sensor data based on a category of the sensor data and select an analysis algorithm for learning in accordance with the classified sensor data.

The analysis execution unit of the server may extract at least one of the sensor data and the teacher data to be added to improve analysis performance based on the analysis result of the sensor data, notify at least one of the sensor terminal and the teacher data input terminal of the sensor data or the teacher data, and the sensor terminal and the teacher data input terminal may transmit to the server, only data corresponding to at least one of the sensor data and the teacher data to be added.

The analysis algorithm of the classifier generation unit may be at least one of a geometric model that makes an analysis based on the sensor data or a geometric structure with a feature value obtained from the sensor data, a probability model that makes an analysis based on a probability and a logical model that makes an analysis based on a logical determination.

The sensor mounted on the sensor terminal may be at least one of a biological potential sensor, an acceleration sensor, a temperature sensor, and a position sensor.

In order to solve the above-described problems, a data analysis method of embodiments of the present invention is a data analysis method for a data analysis system, the data analysis system including a sensor terminal that measures sensor data, a teacher data input terminal for inputting teacher data and a server that generates a classifier through learning using the sensor data and the teacher data, in which the sensor terminal transmits the measured sensor data to the server, receives the classifier generated by the server, analyzes the sensor data using the classifier and transmits the analysis result of the analysis to the server, the teacher data input terminal transmits the inputted teacher data to the server, and the server generates a classifier through learning using the sensor data received from the sensor terminal and the teacher data received from the teacher data input terminal, analyzes the sensor data using the classifier, transmits the classifier to the sensor terminal, and receives the analysis result from the sensor terminal.

### Effects of Embodiments of the Invention

According to embodiments of the present invention, it is possible to provide a data analysis system capable of reducing both pressure on a network band through transmission/reception of sensor data when making a data analysis and delay when the data analysis result is reflected.

### BRIEF DESCRIPTION OF THE DRAWINGS

FIG. 1 is a diagram illustrating a configuration example of a data analysis system according to a first embodiment of the present invention.

FIG. 2 is a diagram illustrating a configuration example of functional blocks of a sensor terminal, a server, and a teacher data input terminal constituting a data analysis system according to the first embodiment of the present invention.

FIG. 3 is a diagram illustrating a sequence example of a data analysis method in the data analysis system according to the first embodiment of the present invention.

FIG. 4A is a diagram illustrating an example of an analysis processing flowchart in the server in the data analysis system according to the first embodiment of the present invention.

FIG. 4B is a diagram illustrating an example of an analysis processing flowchart in the sensor terminal in the data analysis system according to the first embodiment of the present invention.

FIG. 5 is a diagram illustrating a sequence example of a data analysis method in a data analysis system according to a second embodiment of the present invention.

FIG. 6 is a diagram illustrating an example of an analysis processing flowchart in the server in the data analysis system according to the second embodiment of the present invention.

FIG. 7 is a diagram illustrating a sequence example of a data analysis method in a data analysis system according to a third embodiment of the present invention.

FIG. 8 is a diagram illustrating an example of an analysis processing flowchart in the server in the data analysis system according to the third embodiment of the present invention.

FIG. 9 is a diagram illustrating a configuration example of a data analysis system according to a fourth embodiment of the present invention.

FIG. 10 is a diagram illustrating a configuration example of functional blocks of a category signal input terminal and a server constituting the data analysis system according to the fourth embodiment of the present invention.

FIG. 11 is a diagram illustrating a sequence example of a data analysis method in the data analysis system according to the fourth embodiment of the present invention.

FIG. 12 is a diagram illustrating a configuration example of a conventional data analysis system.

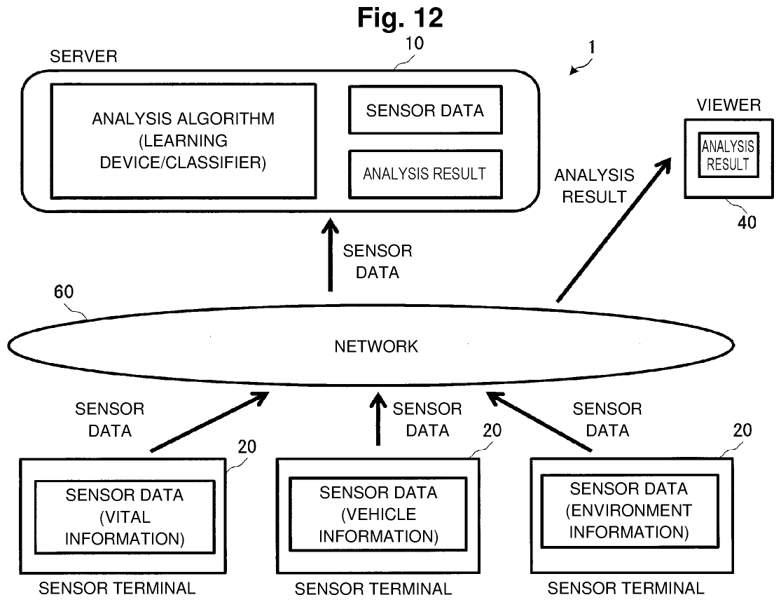

### DETAILED DESCRIPTION OF ILLUSTRATIVE EMBODIMENTS

Hereinafter, embodiments of the present invention will be described with reference to the accompanying drawings. However, the present invention can be made in many different modes, and the present invention should not be construed as limited to the embodiments of the present invention, which will be described hereinafter.

### First Embodiment

Configuration of Data Analysis System

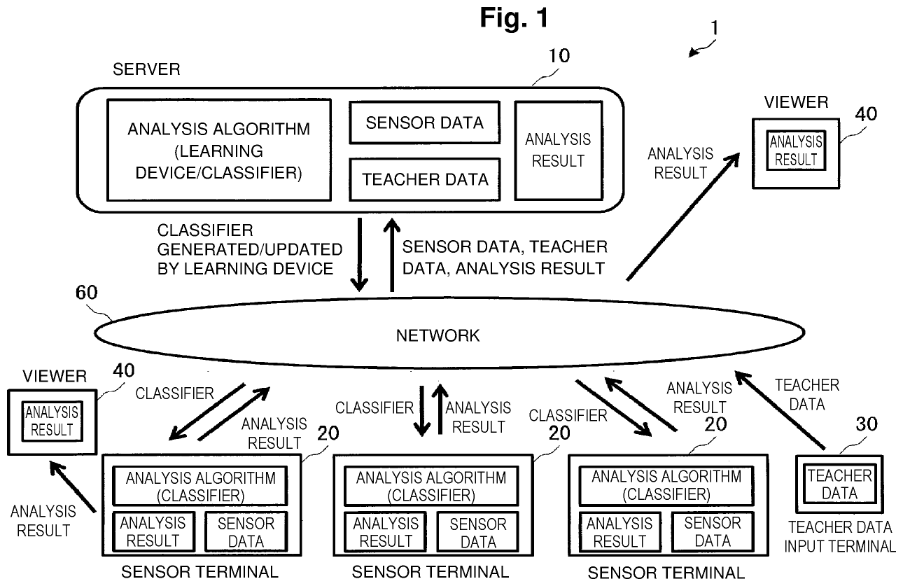

FIG. 1 is a diagram illustrating a configuration example of a data analysis system according to a first embodiment of the present invention. A data analysis system 1 according to the present embodiment is constructed of a sensor terminal 20 that measures sensor data and can perform bidirectional communication, a server 10 that performs learning using sensor data and teacher data, a teacher data input terminal 30 that transmits teacher data and a viewer 40 that displays an analysis result.

These devices perform communication via a network 60 using LTE (registered trademark), 3G, LAN, Wi-Fi (registered trademark) or the like, which are general network standards, and the analysis results are displayed using a general viewer such as a PC, a smartphone, or a tablet.

According to the current system, both the function of learning features of sensor data using the sensor data and the teacher data, that is, a learning device, and the function of making an analysis according to an analysis algorithm acquired through learning, that is, a classifier, are disposed on the server as one analysis algorithm and learning and analysis of data are performed at the server.

Here, since the learning device often carries out iterative operations such as sequential optimization, high calculation capability is required for hardware. On the other hand, the classifier often operates with minor calculations. Thus, the data analysis system 1 of embodiments of the present invention is configured to clone the classifier on the server acquired through learning to the sensor terminal 20 so that the sensor terminal 20 analyzes the sensor data.

The data analysis system 1 is similar to the current system in that the server 10 accumulates the sensor data transmitted from the sensor terminal 20 and the learning device in the server 10 performs learning and generates the classifier. However, according to the embodiments of present invention, when the server 10 performs learning using the learning device and generates the classifier, the server 10 transmits the generated classifier to the sensor terminal 20. The sensor terminal 20 clones the same classifier within the sensor terminal 20 and analyzes the sensor data within the sensor terminal 20 without transferring the sensor data to the server 10. After receiving the classifier, the sensor terminal 20 can analyze the sensor data within the sensor terminal 20 using the classifier, and can transmit only the analysis result to the server 10.

Generally, since most of the sensor data is surplus data, so-called exhaust data for which the purpose of use is undefined, transmission of the sensor data presses a band of the network 60. On the other hand, the data amount of the analysis result of the sensor data using the classifier is quite small compared to the data amount of the sensor data, and so making analyses within the sensor terminal 20 makes it possible to reduce pressure on the band of the network 60.

Since analyses are completed within the sensor terminal 20, the sensor terminal 20 can directly transmit the analysis result to the viewer 40 using Bluetooth (registered trademark) communication or the like without going through the server 10 or the network 60, and can thereby reduce delay in displaying the analysis result.

Here, the analysis algorithm in the learning device or the classifier of the server 10 may also be a geometric model that performs classification based on a geometric structure such as a straight line, space or plane with respect to the sensor data or feature values obtained from the sensor data. One typical example of the geometric model is a support vector machine.

Regarding the support vector machine, learning using the learning device in the server 10 means performing parameter tuning, obtaining a support vector and obtaining an identification function. An analysis made by the classifier means classifying unknown data or a feature value thereof using the obtained identification function. Transmitting the classifier of the server 10 means transmitting a parameter tuned to the identification function. Cloning the classifier within the sensor terminal 20 means cloning the learned identification function using the parameter tuned to the identification function.

For the analysis algorithm in the learning device and the classifier of the server 10, it is possible to use not only the geometric model but also other models. It is also possible to use a probability model that makes an analysis based on probability represented by a neural network or a Bayse classifier or a logical model that makes an analysis based on a logical determination as to whether sensor data or a feature value thereof satisfies a certain condition or not using a decision tree or the like.

Note that although the feature value is not necessarily used, if the feature value is used, a designer may specify the feature value in advance and provide a step of applying calculations before performing learning using the learning device. Calculations of feature values are a first-stage process common to both learning and classification, and can be regarded as part of the learning device or the classifier. A deep neural network, which is an analysis algorithm that automatically generates a feature value is one such example.

The model according to the aforementioned analysis algorithm is common in that the learning device performs parameter tuning and determines an identification function and the classifier makes an analysis on unknown sensor data as basic operations. A classifier learned in advance as an initial state may be preinstalled in the sensor terminal 20 and the server 10 so that analyses may be conducted even before initial learning is performed.

<Functional Blocks of Sensor Terminal, Server, and Teacher Data Input Terminal>

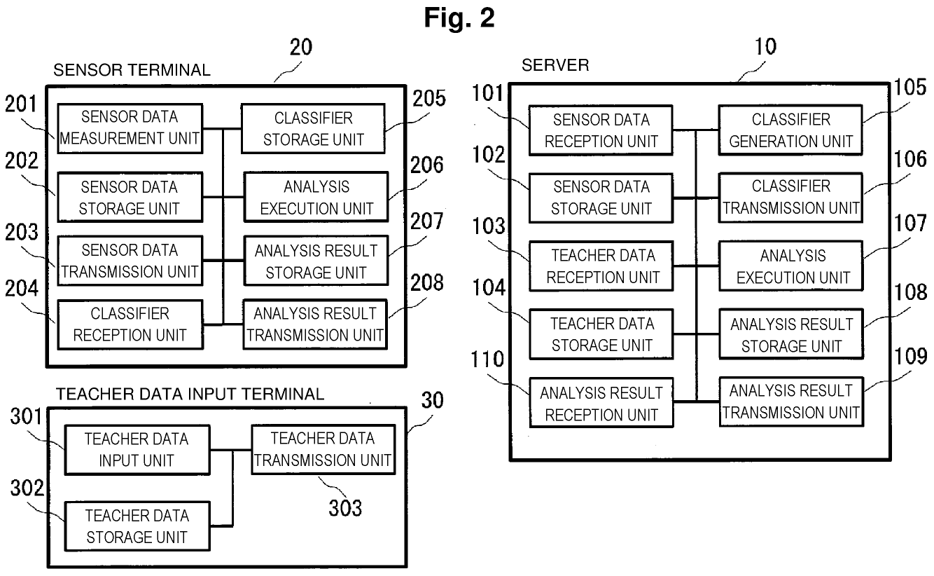

FIG. 2 is a diagram illustrating a configuration example of functional blocks of a sensor terminal, a server, and a teacher data input terminal constituting a data analysis system according to the first embodiment of the present invention.

The sensor terminal 20 is provided with a sensor data measurement unit 201, a sensor data storage unit 202, a sensor data transmission unit 203, a classifier reception unit 204, a classifier storage unit 205, an analysis execution unit 206, an analysis result storage unit 207, and an analysis result transmission unit 208. The sensor data measurement unit 201 measures sensor data. The sensor data storage unit 202 stores the measured sensor data for a certain period of the time. The sensor data transmission unit 203 transmits the measured sensor data to the server. The classifier reception unit 204 receives the classifier generated by the server. The classifier storage unit 205 stores the received classifier. The analysis execution unit 206 analyzes the sensor data using the received classifier. The analysis result storage unit 207 stores the analysis result for a certain period of the time. The analysis result transmission unit 208 transmits the analysis result to the server or the viewer.

The sensor data measurement unit 201 is mounted with various sensors such as a biological potential sensor, an acceleration sensor, a temperature sensor, or a position sensor in accordance with the sensor data to be measured. When an existing classifier is present, the classifier storage unit 205 updates the classifier by replacing the existing classifier with the received classifier.

The server 10 is provided with a sensor data reception unit 101, a sensor data storage unit 102, a teacher data reception unit 103, a teacher data storage unit 104, a classifier generation unit 105, a classifier transmission unit 106, an analysis execution unit 107, an analysis result storage unit 108, an analysis result transmission unit 109, and an analysis result reception unit 110. The sensor data reception unit 101 receives sensor data from the sensor terminal 20. The sensor data storage unit 102 stores the sensor data. The teacher data reception unit 103 receives teacher data to be used for learning. The teacher data storage unit 104 stores the teacher data. The classifier generation unit 105 generates a classifier through learning using the sensor data and the teacher data. The classifier transmission unit 106 transmits the generated classifier to the sensor terminal. The analysis execution unit 107 analyzes the sensor data using the classifier. The analysis result storage unit 108 stores the analysis result for a certain period of the time. The analysis result transmission unit 109 transmits the stored analysis result to the viewer. When an analysis is made at the sensor terminal 20, the analysis result reception unit 110 receives the analysis result.

The teacher data input terminal 30 is provided with a teacher data input unit 301 to which a user inputs teacher data, a teacher data storage unit 302 that stores the inputted teacher data, and a teacher data transmission unit 303 that transmits the stored teacher data.

Note that the server 10 may also be constructed of a computer provided with a storage unit, I/F unit and a central processing unit, and may also be configured such that processing by the central processing unit is executed according to a program. In such a case, the storage unit functions as the sensor data storage unit and the teacher data storage unit analysis result storage unit, and the central processing unit functions as the learning device or the classifier. The central processing unit may be mounted with a program of an analysis algorithm in advance or a program may be stored in the storage unit and the program may be downloaded to the central processing unit.

Sequence of Data Analysis Method

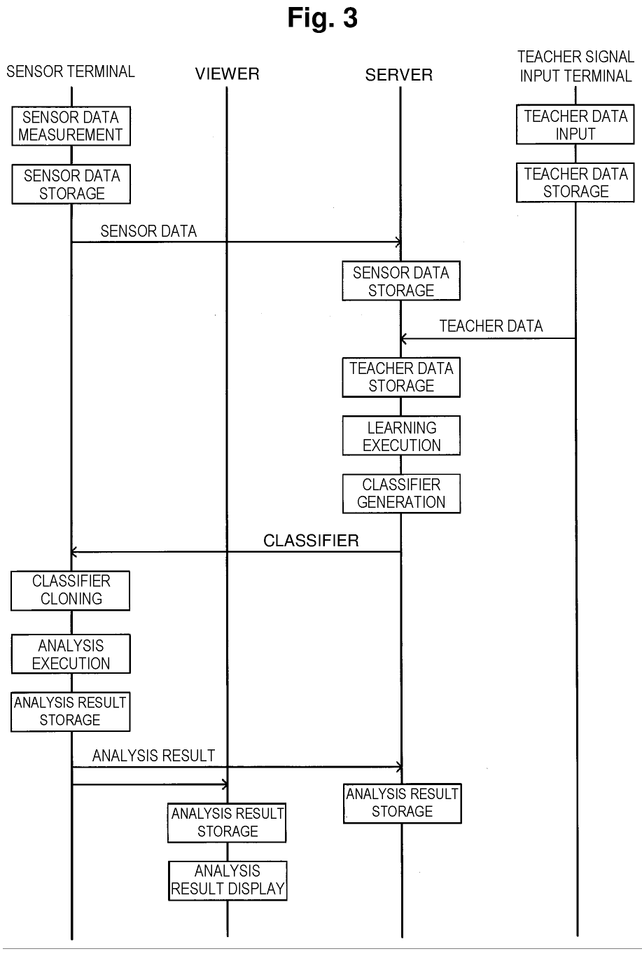

FIG. 3 is a diagram illustrating a sequence example of a data analysis method in the data analysis system according to the first embodiment of the present invention.

The sensor terminal measures predetermined sensor data using the various sensors mounted therein, stores the sensor data in the sensor terminal and transmits the measured sensor data to the server. On the other hand, the teacher data input terminal stores the inputted teacher data and transmits the teacher data to the server.

The server executes learning using the sensor data transmitted from the sensor terminal and the teacher data transmitted from the teacher data input terminal, thereby generates a classifier and transmits the generated classifier to the sensor terminal.

The sensor terminal analyzes the sensor data using the classifier transmitted from the server and transmits the analysis result obtained to the server. The server stores the analysis result transmitted from the sensor terminal. The sensor terminal can also directly transmit the analysis result obtained to the viewer to thereby display the analysis result on the viewer as required.

Analysis Processing Flowchart

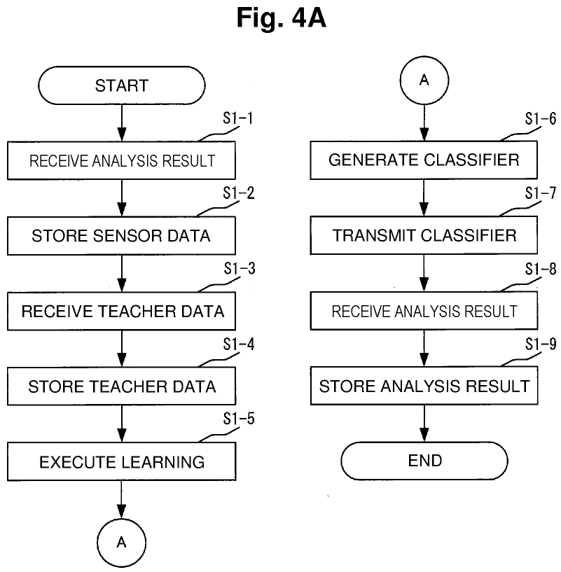

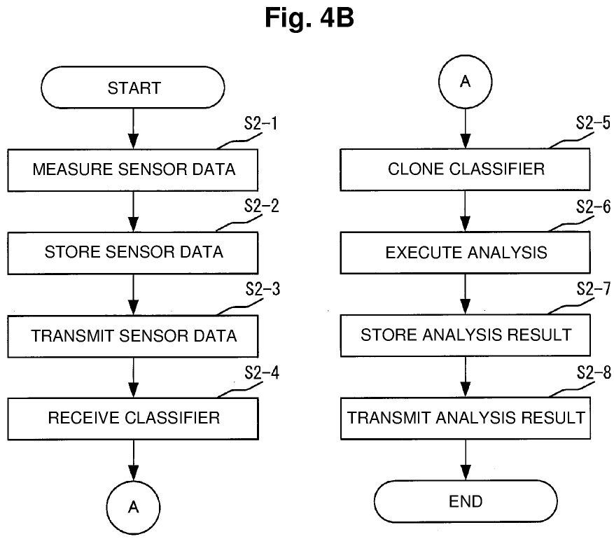

FIG. 4A and FIG. 4B are diagrams illustrating an example of an analysis processing flowchart in the server and the sensor terminal in the data analysis system according to the first embodiment of the present invention. FIG. 4A is an analysis processing flowchart in the server and FIG. 4B is an analysis processing flowchart in the sensor terminal.

The server stores the sensor data received from the sensor terminal and the teacher data received from the teacher data input terminal (S1-1 to S1-4), executes learning using the sensor data and the teacher data, thereby generates a classifier and transmits the generated classifier to the sensor terminal (S1-5 to S1-7).

When the sensor terminal analyzes the sensor data, the server receives and stores the analysis result of the sensor data (S1-8 to S1-9).

On the other hand, the sensor terminal measures and stores predetermined sensor data, and transmits the measured sensor data to the server (S2-1 to S2-3).

When the sensor terminal receives the classifier from the server, the sensor terminal analyzes the sensor data using the received classifier, stores the analysis result obtained and transmits the analysis result obtained to the server or the viewer (S2-4 to S2-8).

Thus, according to the present embodiment, of the learning device and the classifier, the classifier having a smaller amount of operation is transmitted and cloned to the sensor terminal, and so after transmitting a certain amount of data, it is possible to analyze the sensor data within the sensor terminal or display the sensor data on the viewer without all the sensor terminals sending the whole data to the server, and it is thereby possible to reduce both pressure by the sensor data on the network band and delay in reflecting the analysis result.

### Second Embodiment

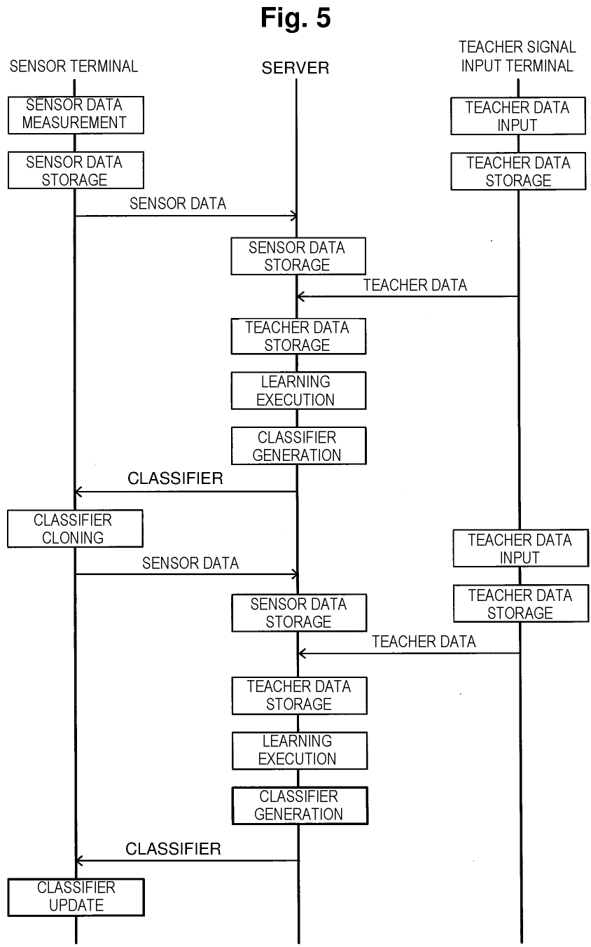

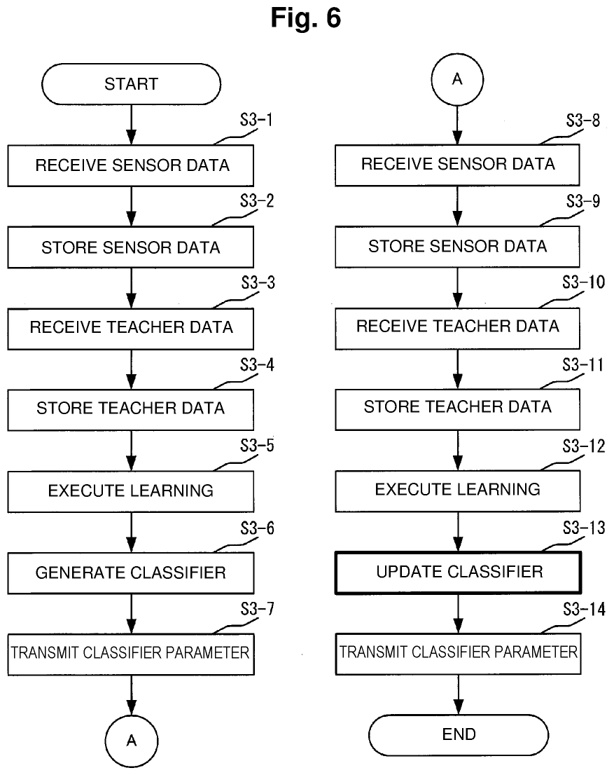

A second embodiment of the present invention will be described using FIGS. 5 and 6. FIG. 5 is a diagram illustrating a sequence example of a data analysis method in a data analysis system according to a second embodiment of the present invention. FIG. 6 is a diagram illustrating an example of an analysis processing flowchart in the server in the data analysis system according to the second embodiment of the present invention. Compared to FIGS. 3 and 4, FIGS. 5 and 6 are characterized in that processing of updating the classifier is performed.

In the second embodiment, even after a first classifier is generated, some of the plurality of sensor terminals 20 do not stop transmission of sensor data, and some of the plurality of teacher data input terminals 30 continue to transmit teacher data to the server 10. The transmitted sensor data and teacher data are continuously stored in the server 10, and after a certain amount of data is stored, the server 10 executes relearning and thereby updates the classifier. The updated classifier is transmitted to the sensor terminal 20 that has transmitted the sensor data via the network 60 and the classifier within the sensor terminal 20 is updated.

Note that both some of the sensor terminals 20 and some of the teacher data input terminals 30 may be configured to continue to transmit data or either some of the sensor terminals 20 or some of the teacher data input terminals 30 may be configured to continue to transmit sensor data and teacher data, and update the classifier.

In this way, according to the present embodiment, even after the first classifier is generated, by continuing to transmit part of sensor data and teacher data, it is possible to perform relearning after expanding the data scale of the stored sensor data, continuously improve reliability of the classifier and reduce pressure on the network band, and improve reliability of the classifier at the same time.

### Third Embodiment

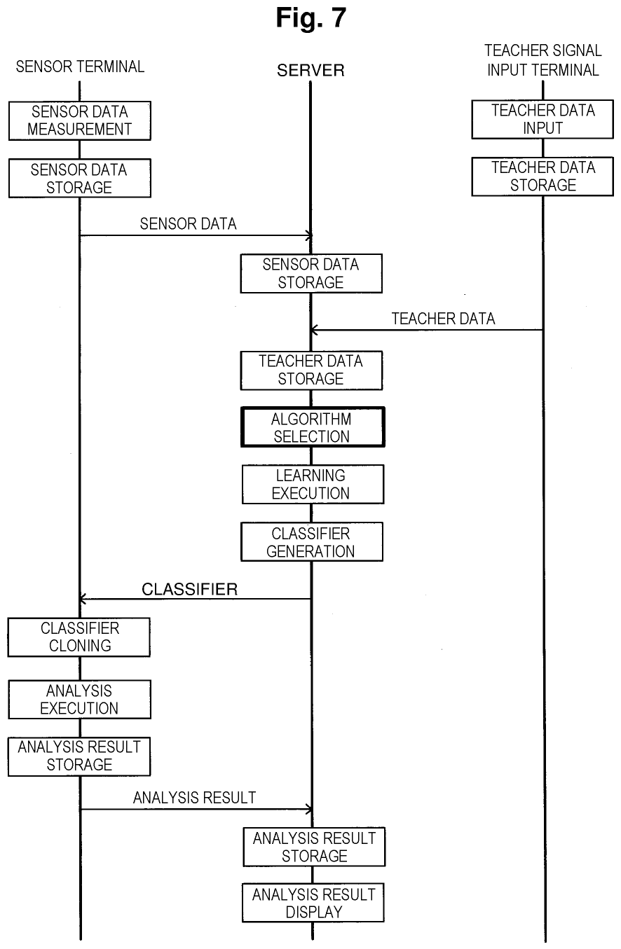

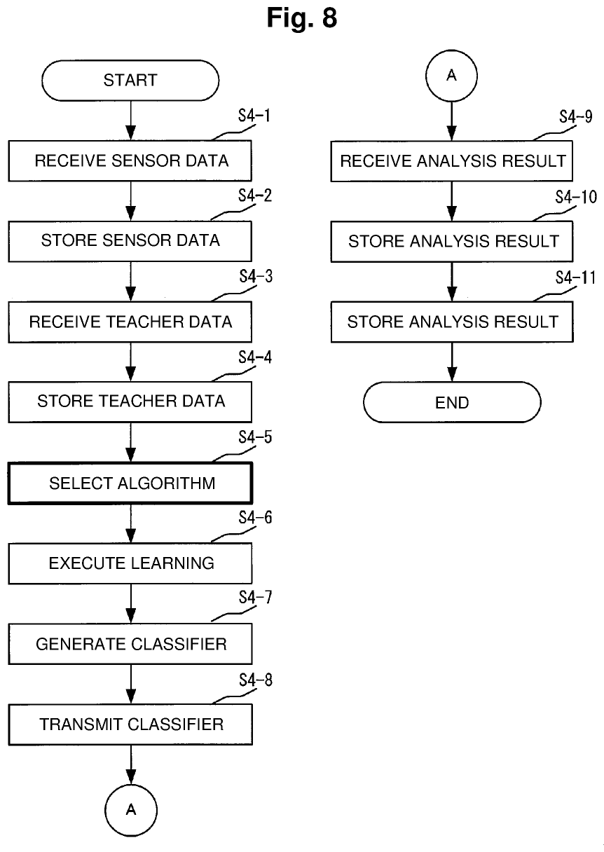

A third embodiment of the present invention will be described using FIGS. 7 and 8. FIG. 7 is a diagram illustrating a sequence example of a data analysis method in a data analysis system according to a third embodiment of the present invention. FIG. 8 is a diagram illustrating an example of an analysis processing flowchart in the server in the data analysis system according to the third embodiment of the present invention. The data analysis system according to the third embodiment is provided with a plurality of analysis algorithms, that is, a plurality of learning devices and classifiers and selects an analysis algorithm from among the plurality of analysis algorithms in accordance with the scale and the type of data stored in the server and analysis performance of the classifier. Compared to FIGS. 3 and 4, FIGS. 7 and 8 are characterized in that processing of selecting an algorithm is performed.

The analysis algorithm for learning in the data analysis system varies in reliability depending on the scale and type of sensor data and teacher data. For example, the deep neural network is known to be able to discover diseases that cannot be discovered by humans or demonstrate overwhelming strength in shogi (Japanese chess) or the like. High analysis performance is expected even when sensor data is analyzed, but learning requires several thousands to several tens of thousands of sets of data and teacher data. On the other hand, the support vector machine can achieve high analysis performance with a relatively small number of data sets.

In the third embodiment, an analysis algorithm for performing appropriate learning is selected according to the scale and type of sensor data. It is possible to provide a classifier having optimum analysis performance by selecting an analysis algorithm in accordance with the scale of data set, for example, when the number of data sets is several tens to several hundreds, a classifier is generated using the support vector machine, and when the number of data sets exceeds several thousands, the classifier is updated to one using the deep neural network. When sensor data with few feature values is analyzed and the like, it is also possible to select an analysis algorithm according to the type of sensor data by generating a classifier using the support vector machine, etc.

It may also be possible to cause the server to parallelly calculate learning of a plurality of analysis algorithms including the support vector machine and the deep neural network, select an analysis algorithm according to the analysis performance such as selecting an analysis algorithm that best matches the teacher data.

Thus, according to the present embodiment, an analysis algorithm is selected in accordance with the scale or the type of sensor data and teacher data, and it is thereby possible to select an appropriate analysis algorithm in accordance with the scale or the type of sensor data and teacher data, and further select an appropriate analysis algorithm for each sensor terminal that measures different sensor data.

### Fourth Embodiment

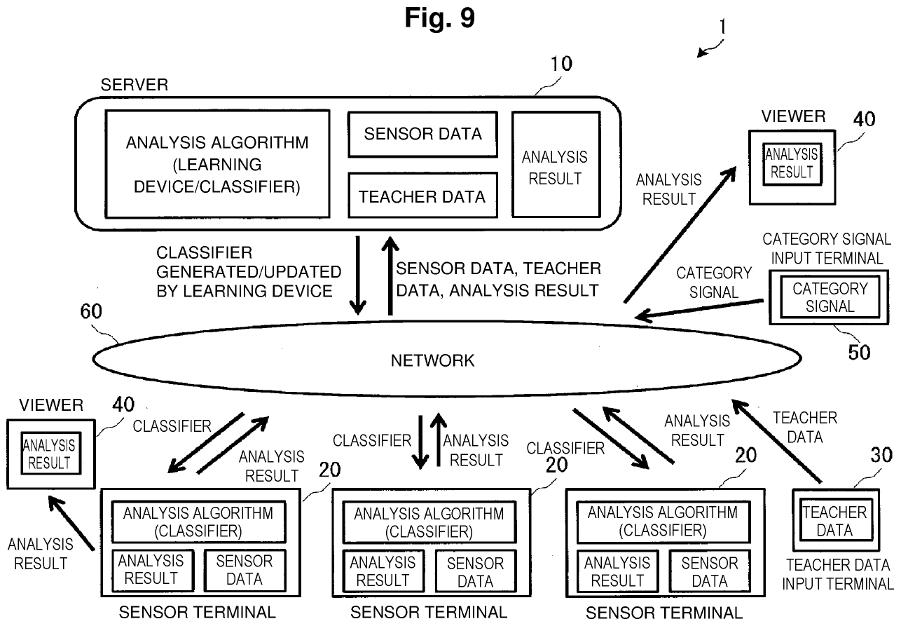

FIG. 9 is a diagram illustrating a configuration example of a data analysis system according to a fourth embodiment of the present invention. The data analysis system according to the fourth embodiment classifies a data set of sensor data and teacher data in accordance with a category or the like of the sensor data and performs learning. In a configuration example in FIG. 9, a category signal is inputted from a category signal input terminal 50 connected to the network 60.

When large-scale sensor data is analyzed, it is important to secure reliability over an entire population of the sensor data. In this case, it is often the case that reliability cannot be obtained for atypical users. For example, in the case of an analysis algorithm that analyzes a cardiac rate from a cardiogram obtained from sensor data of a biological potential sensor, if most of users are healthy people, reliability of an analysis of minority users having arrhythmia is low. When a user's behavior is analyzed, the same thing can be said about gait of a healthy person and gait of a half-body paralyzed patient obtained from data of an acceleration sensor or a feature value thereof. Furthermore, in the case of an analysis of detection of operation, track or abnormality of an automobile obtained from data of a position sensor, a temperature sensor or a control sensor, the analysis result may show that reliability is secured for ordinary cars, which correspond to a majority of the data, whereas reliability of the analysis result relating to large buses, which correspond to a minority of the data becomes dubious.

Thus, in the present embodiment, learning is conducted by inputting category signals of sensor data such as the presence or absence of a chronic disease or a model of a car and classifying a data set of sensor data and teacher data in accordance with the inputted category signals. Thus, instead of analyzing all the data using a single analysis algorithm across the board, all the data that can be learned in common throughout a population is analyzed using one algorithm. When such an analysis is not possible, data is classified into populations which differ category by category and can be analyzed as different populations, and so it is possible to make a highly reliable analysis. In the case where the data scale of a population decreases as a result of classification per category, it is also possible to select an analysis algorithm in accordance with the data scale.

The category signal input terminal 50 for inputting category signals can also allow the user to input as a category signal, the user's request regarding a data attribute as to whether the data should be analyzed with the same attribute as data of part of a population or with an individual attribute as a different category.

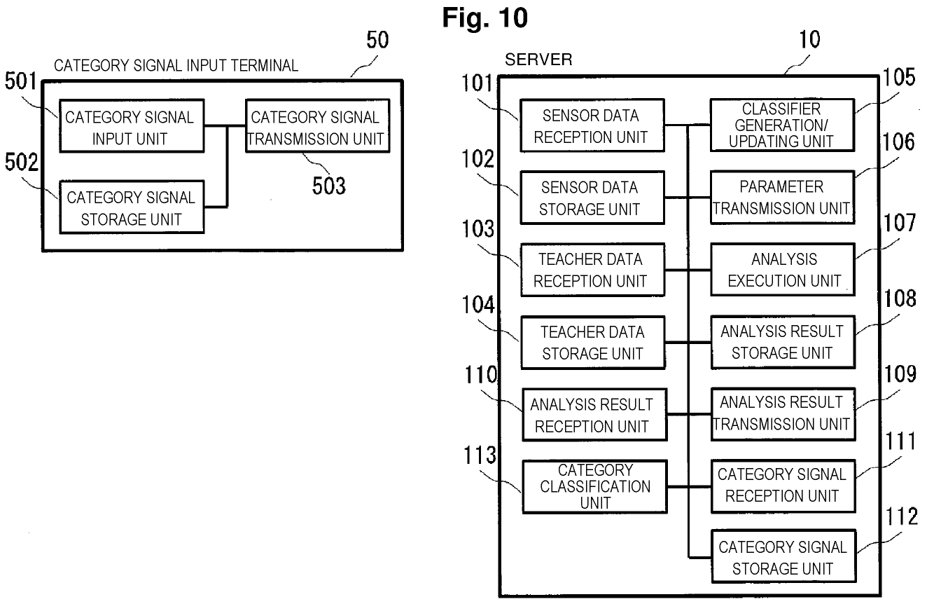

FIG. 10 is a diagram illustrating a configuration example of functional blocks of the category signal input terminal and the server constituting the data analysis system of the fourth embodiment of the present invention. The configurations of the sensor terminal 20 and the teacher data input terminal 30 are similar to the configurations of the first embodiment. In addition to the configuration of the first embodiment, the server 10 is provided with a category signal reception unit 111 that receives a category signal, a category signal storage unit 112 that stores the category signal, and a category classification unit 113 that classifies a set of sensor data and teacher data based on a category when performing learning.

The category signal input terminal 50 is provided with a category signal input unit 501 for the user to input a category signal, a category signal storage unit 502 that stores the inputted category signal, and a category signal transmission unit 503 that transmits the stored category signal.

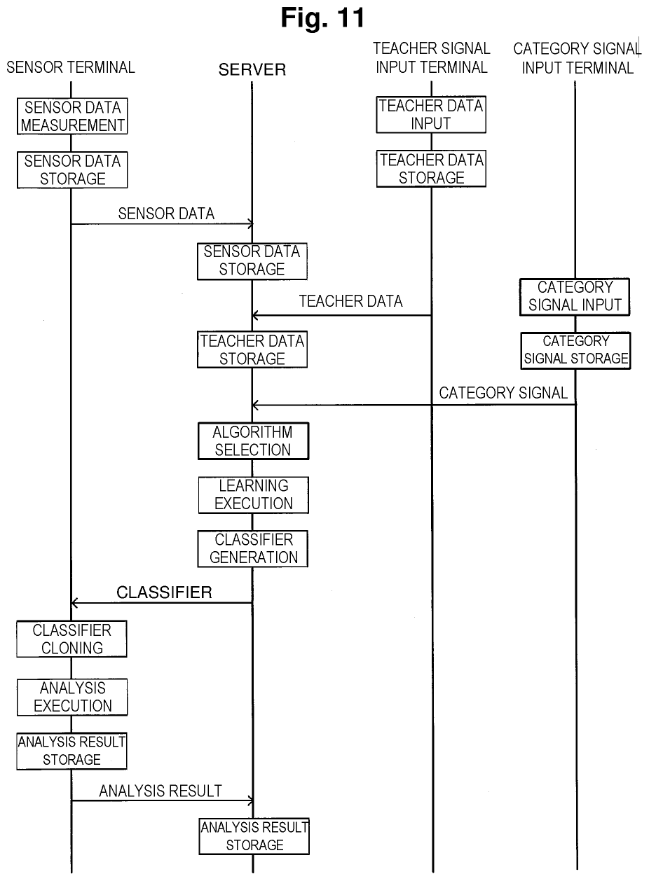

FIG. 11 is a diagram illustrating a sequence example of a data analysis method in the data analysis system according to the fourth embodiment of the present invention. While in the third embodiment, an analysis algorithm is selected in accordance with the scale or the like of sensor data and teacher data, in the present embodiment, an analysis algorithm is selected according to the category of sensor data. Note that selection of an analysis algorithm in accordance with the scale or the like of sensor data and teacher data according to the third embodiment and selection of an analysis algorithm in accordance with the category of sensor data may be combined.

In this way, since the present embodiment is configured such that an analysis algorithm is selected according to the category of sensor data, it is possible to select an appropriate analysis algorithm in accordance with the category of sensor data and make a highly reliable analysis.

### Fifth Embodiment

A data analysis system according to a fifth embodiment selectively uses analyses not only according to supervised learning but also according to unsupervised learning, semi-supervised learning, and cooperative learning.

The analysis algorithm includes supervised learning that requires teacher data and unsupervised learning that requires no teacher data. Furthermore, the supervised learning includes semi-supervised learning in cases where teacher data corresponds to only a certain part of data or only uncertain teacher data can be obtained so that it is only known whether there is at least one piece of correct answer data in a certain data group. The present embodiment selectively uses analyses according to supervised learning, semi-supervised learning, unsupervised learning, or cooperative learning in accordance with an input state of teacher data.

For example, when the user chooses to analyze data as an individual attribute as the category but the user does not transmit teacher data at all, supervised learning cannot be performed. In such a case, a classifier according to unsupervised learning or cooperative learning using learning results of data of other categories is generated or updated. Furthermore, a case may also be assumed where teacher data is initially transmitted but teacher data is no longer transmitted from a certain point in time. In this case, semi-supervised learning may be used.

For example, supervised learning, semi-supervised learning or unsupervised learning is selectively used in such a way that supervised learning is performed when teacher data is linked with 80% or more of all the data, and the remaining 20% of the data is not used for learning, whereas semi-supervised learning is used when teacher data is linked with 80% or less and 20% or more of all the data. Furthermore, unsupervised learning is used when teacher data is linked with 20% or less of all the data.

Thus, according to the present embodiment, by selectively using analyses not only according to supervised learning but also according to unsupervised learning, semi-supervised learning or cooperative learning, updating of the classifier and reliability improvement can be continued through learning even when it is not possible to obtain abundant teacher data.

### Sixth Embodiment

A data analysis system according to a sixth embodiment collects data based on active learning or the like, thereby extracts data requiring teacher data in advance or a class of necessary teacher data and notifies the sensor terminal or the teacher data input terminal of the data or the class. The sensor terminal transmits sensor data only when the notified sensor data is obtained and the teacher data input terminal transmits the data to the server only when the data corresponding to the necessary teacher data is obtained.

In the aforementioned second embodiment, some sensor terminals or some teacher data input terminals continuously transmit data, and thereby update the classifier. Here, since an appearance frequency of each piece of data considerably differs in actual data analyses, many pieces of frequent data may become data that does not contribute to an improvement of analysis performance. Thus, in the present embodiment, the server performs active learning, selects an active class or collects data based on Bayse optimization, and thereby extracts sensor data requiring teacher data to improve analysis performance in learning or a class of necessary teacher data and notifies the sensor terminal or the teacher data input terminal of the sensor data or the class of the teacher data in advance. The sensor terminal and the teacher data input terminal transmit data to the server only when the specified sensor data and data corresponding to the necessary teacher data are obtained.

In the present embodiment, it is possible to limit data to be transmitted to the server to only data for improving analysis performance, and it is thereby possible to reduce pressure on the network band and additional learning costs of the analysis algorithm. In the case where teacher data is added ex post facto, it is also possible to reduce costs associated with the addition of the teacher data.

Furthermore, if active learning, which is one of frameworks of machine learning that causes the classifier to learn by asking experts is used, it is possible to limit data to be continuously transmitted to data that is effective in improving performance of the analysis algorithm and thereby more effectively eliminate the trade-off between an improvement of network traffic and an improvement of reliability of the analysis algorithm.

### REFERENCE SIGNS LIST

1 data analysis system

10 server

20 sensor terminal

30 teacher data input terminal

40 viewer

50 category signal input terminal

60 network

1-8. (canceled)

9. A data analysis system comprising:
a sensor terminal that measures sensor data;
a teacher data input terminal that receives teacher data; and
a server that generates a classifier according to learning through the sensor data and the teacher data;
wherein the sensor terminal comprises:
a sensor data transmitter that transmits the sensor data to the server;
a classifier receiver that receives the classifier generated by the server;
a first analysis execution processor that analyzes the sensor data according to the classifier; and
an analysis result transmitter that transmits an analysis result of the first analysis execution processor to the server;
wherein the teacher data input terminal comprises a teacher data transmitter that transmits the teacher data to the server; and
wherein the server comprises:
a classifier generator that generates the classifier according to learning through the sensor data and the teacher data;
a second analysis execution processor that analyzes the sensor data according to the classifier;
a classifier transmitter that transmits the classifier to the sensor terminal; and
an analysis result receiver that receives the analysis result from the sensor terminal.

10. The data analysis system according to claim 9, further comprising a plurality of sensor terminals and a plurality of teacher data input terminals, wherein:
the sensor terminal is one of the plurality of sensor terminals and the teacher data input terminal is one of the plurality of the teacher data input terminals;
one of more of the plurality of sensor terminals transmits updated sensor data after the classifier is generated or one or more of the plurality of teacher data input terminals transmits updated teacher data after the classifier is generated;
the classifier generator generates an updated classifier through re-learning according to the updated sensor data or the updated teacher data; and
the classifier transmitter transmits the updated classifier to the one or more of the plurality of sensor terminals.

11. The data analysis system according to claim 9, wherein the classifier generator selects an analysis algorithm from a plurality of analysis algorithms to learn according to a scale of the sensor data, a type of the sensor data, a scale of the teacher data, a type of the teacher data, or analysis performance of the classifier.

12. The data analysis system according to claim 9, wherein the classifier generator classifies the sensor data according to a category of the sensor data and selects an analysis algorithm for learning in accordance with a classification of the sensor data.

13. The data analysis system according to claim 9, wherein:
the first analysis execution processor extracts the sensor data or the teacher data to be added to improve analysis performance based on the analysis result of the sensor data and notifies the sensor terminal or the teacher data input terminal of the sensor data or the teacher data to be added; and
the sensor terminal or the teacher data input terminal transmit, to the server, only data corresponding the sensor data or the teacher data to be added.

14. The data analysis system according claim 9, wherein an analysis algorithm of the classifier generator is a geometric model that makes an analysis based on the sensor data or a geometric structure with a feature value obtained from the sensor data, a probability model that makes an analysis based on a probability, or a logical model that makes an analysis based on a logical determination.

15. The data analysis system according to claim 9, wherein a sensor mounted on the sensor terminal is a biological potential sensor, an acceleration sensor, a temperature sensor, or a position sensor.

16. A data analysis method for a data analysis system, the method comprising:
measuring, by a sensor terminal of the data analysis system, sensor data;
receiving, by a teacher data input terminal of the data analysis system, teacher data input into the teacher data input terminal; and
generating, a server by the data analysis system, a classifier according to learning through the sensor data and the teacher data;
wherein the sensor terminal transmits the sensor data to the server, receives the classifier generated by the server, analyzes the sensor data according to the classifier, and transmits an analysis result of analyzing the sensor data to the server;
wherein the teacher data input terminal transmits the teacher data to the server; and
wherein the server generates the classifier, analyzes the sensor data according to the classifier, transmits the classifier to the sensor terminal, and receives the analysis result from the sensor terminal.

17. The data analysis method according to claim 16, wherein:
the data analysis system further comprises a plurality of sensor terminals and a plurality of teacher data input terminals;
the sensor terminal is one of the plurality of sensor terminals and the teacher data input terminal is one of the plurality of the teacher data input terminals;
one of more of the plurality of sensor terminals transmits updated sensor data after the classifier is generated or one or more of the plurality of teacher data input terminals transmits updated teacher data after the classifier is generated;
the server generates an updated classifier through re-learning according to the updated sensor data or the updated teacher data; and
the server transmits the updated classifier to the one or more of the plurality of sensor terminals.

18. The data analysis method according to claim 16, wherein the server an analysis algorithm from a plurality of analysis algorithms to learn according to a scale of the sensor data, a type of the sensor data, a scale of the teacher data, a type of the teacher data, or analysis performance of the classifier.

19. The data analysis method according to claim 16, wherein the server classifies the sensor data according to a category of the sensor data and selects an analysis algorithm for learning in accordance with a classification of the sensor data.

20. The data analysis method according to claim 16, wherein:
the sensor terminal extracts the sensor data or the teacher data to be added to improve analysis performance based on the analysis result of the sensor data and notifies the sensor terminal or the teacher data input terminal of the sensor data or the teacher data to be added; and
the sensor terminal or the teacher data input terminal transmit, to the server, only data corresponding the sensor data or the teacher data to be added.

21. The data analysis method according to claim 16, wherein an analysis algorithm of the server is a geometric model that makes an analysis based on the sensor data or a geometric structure with a feature value obtained from the sensor data, a probability model that makes an analysis based on a probability, or a logical model that makes an analysis based on a logical determination.

22. The data analysis method according to claim 16, wherein a sensor mounted on the sensor terminal is a biological potential sensor, an acceleration sensor, a temperature sensor, or a position sensor.
